(19) United States
(12) Patent Application Publication
(10) Pub. No.: US 2003/0041818 A1
(43) Pub. Date: Mar. 6, 2003

(54) Internal combustion engine fuel check valve

(76) Inventors: William T. Cobb JR., St. Petersburg, FL (US); Patrick Alan McCreery, Charlotte, NC (US)

Correspondence Address: HARRINGTON & SMITH, LLP, 4 RESEARCH DRIVE, SHELTON, CT, 06484-6212, US

(21) Appl. No.: 09/947,100

(22) Filed: Sep. 5, 2001

(51) Int. Cl. F02B 33/04

(52) U.S. Cl. 123/73 V

(57) ABSTRACT

An internal combustion engine including a cylinder and a fuel delivery system for delivering a fuel and air mixture into the cylinder. The fuel delivery system has a rapid action check valve located between a fuel source and a conduit to a combustion chamber of the cylinder. The rapid action check valve has a valve body with a channel therethrough and a valve plate connected to a front end of the valve body. The valve plate has an outer section and a center cantilevered flap. The cantilevered flap extends inward from the outer section in a generally cantilevered fashion. The cantilevered flap is located at a front end of the valve body at the channel and is deflectably moveable in a forward direction away from the channel.

### BACKGROUND OF THE INVENTION

1. Field of the Invention

The present invention relates to internal combustion engines and, more particularly, to a fuel check valve used in an internal combustion engine.

2. Prior Art

Many different types of check valves are generally well known in various different types of fluid conduiting technologies. For example, U.S. Pat. No. 4,160,383 discloses a unitary sample-event-valve assembly useful in urological applications. As another example, U.S. Pat. No. 5,261,448 discloses a check valve assembly used in a variable damping force shock absorber for an automotive suspension system. U.S. Pat. No. 5,884,665 discloses an air conditioning read valve support seat surrounded by an annular channel and a reed comprised of spring steel.

In the internal combustion engine technology there is a need for a rapid action fuel check valve which can be used to deliver a fuel and air mixture. In a 2 cycle internal combustion engine the check valve must be able to open and close at a very high frequency, such as 250 cycles per second or more. The fuel check valve must also be able to withstand heat generated from combustion and have a long working life. There is a desire to provide a rapid action fuel check valve which can open and close with very low differences in control pressures. There is also a desire to provide a rapid action fuel check valve which is designed to prevent a significant variation of opening pressure in the presence of liquid films or wetting, such as fuel or oil.

### SUMMARY OF THE INVENTION

In accordance with one aspect of the present invention, an internal combustion engine is provided including a cylinder and a fuel delivery system for delivering a fuel and air mixture into the cylinder. The fuel delivery system comprises a rapid action check valve located between a fuel source and a conduit to a combustion chamber of the cylinder. The check valve is exposed to pressure pulses in the conduit from combustion in the combustion chamber and vacuum pulses in the conduit from movement of a piston in the cylinder. The rapid action check valve comprises a valve body having a channel therethrough and a valve plate connected to a front end of the valve body. The valve plate comprises an outer section and a center cantilevered flap. The outer section has a general ring shape. The cantilevered flap extends inward from the outer section in a general cantilevered fashion. The cantilevered flap is located at a front end of the valve body at the channel and is deflectably moveable in a forward direction away from the channel.

In accordance with another aspect of the present invention, a valve is provided comprising a valve body having a channel therethrough, a valve disc and a cap. The valve disc has an outer section and a flap extending in a cantilever fashion inward from the outer section. The cap is connected to the valve body. The outer section of the valve disk is movably located between the valve body and the cap. The cap has a hole for the flap of the valve desk to move in.

In accordance with another aspect of the present invention, an internal combustion engine fuel check valve is provided comprising a valve body having a channel therethrough, an annular seal connected around an outside of the valve body, a valve plate and a valve cap. The valve plate is comprised of a sheet metal member. The valve plate has an outer section and a cantilevered flap extending from the outer section. The flap is resiliently movable relative to the outer section at a junction between the flap and the outer section. The valve cap is connected to the valve body and captures at least a portion of the outer section between the valve cap and the valve body. The valve cap has an aperture therethrough. The flap is flexibly movable at a front end of the channel at the aperture. The valve body is sized and shaped to be inserted into a conduiting member having a fuel inlet channel connectable to a combustion chamber of an internal combustion engine with the seal being located between the valve body and the conduiting member spaced from the fuel inlet channel.

### BRIEF DESCRIPTION OF THE DRAWINGS

The foregoing aspects and other features of the present invention are explained in the following description, taken in connection with the accompanying drawings, wherein:

FIG. 1 is a schematic perspective view of a power tool having an internal combustion engine incorporating features of the present invention;

FIG. 2 is a cross sectional view of a portion of the engine shown in FIG. 1;

FIG. 3 is a perspective view of one of the components shown in FIG. 2;

FIG. 4 is an exploded perspective view of the check valve shown in FIG. 2;

FIG. 5 is a cross sectional view of the check valve shown in FIG. 4; and

FIG. 6 is a front plan view of the valve plate of the check valve shown in FIGS. 4 and 5.

### DETAILED DESCRIPTION OF THE PREFERRED EMBODIMENT

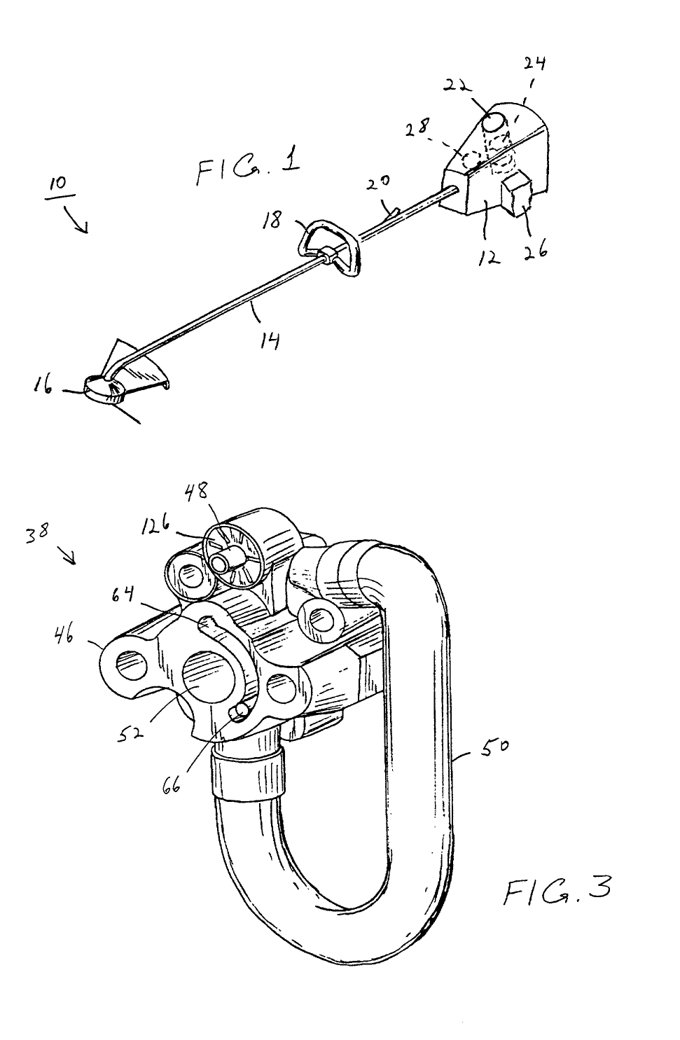

Referring to FIG. 1, there is shown a perspective view of a power tool 10 incorporating features of the present invention. Although the present invention will be described with reference to the single embodiment shown in the drawings, it should be understood that the present invention can be embodied in many alternate forms of embodiments. In addition, any suitable size, shape or type of elements or materials could be used.

The power tool 10, in the embodiment shown, is a string trimmer. However, in alternate embodiments, features of the present invention could be used in any suitable type of tool or device which is powered by an internal combustion engine. For example, features of the present invention could be incorporated into a chain saw, a hedge trimmer, a motorcycle or moped, or a motorboat outboard engine.

The string trimmer 10 generally comprises an internal combustion engine 12, a shaft 14, a string trimmer head 16, a handle 18 and a throttle trigger or control 20. In an alternate embodiment, features of the present invention could be used in any suitable type of string trimmer having an internal combustion engine. The engine 12 generally comprises a cylinder 22, a piston 24, a fuel delivery system 26, and an ignition system 28. The engine could comprise additional components. The engine 12 can be similar to the engines described in U.S. patent application Ser. Nos. 09/138,244; 09/504,056; 09/533,752; 09/589,508; and 09/588,882, assigned to the same assignee as herein, which are hereby incorporated by references in their entireties.

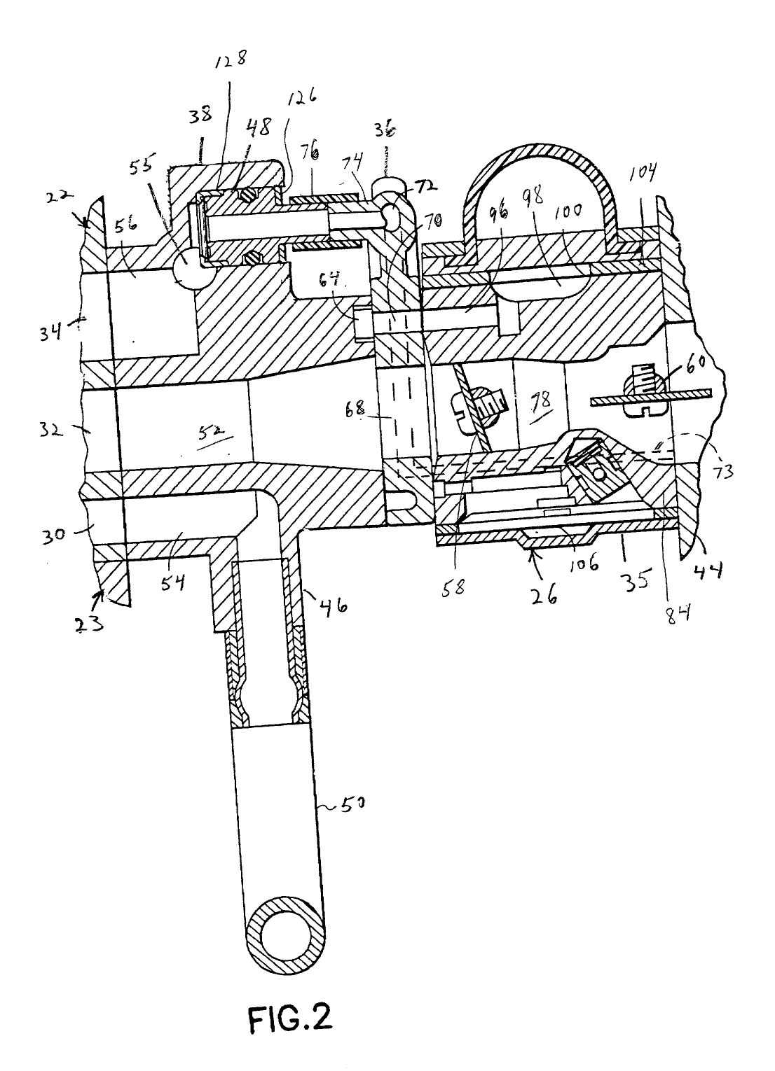

Referring also to FIG. 2, portions of the cylinder 22 and the fuel delivery system 26 are shown. A side of the cylinder 22 includes three apertures 30, 32 and 34. The bottom aperture 30 is in communication with the crankcase of the engine. In a preferred embodiment, the bottom aperture 30 can be selectively opened and closed by the piston 24 as the piston moves towards and away from its bottom dead center position. The middle aperture 32 is a main air entrance for air to enter the crankcase of the engine. The middle aperture 32 is selectively opened and closed by the piston as the piston moves in the cylinder. The top aperture 34 is a fuel and air mixture entrance aperture or injection port. The top aperture 34 can also be selectively open and closed by the piston as the piston moves towards and away from its top dead center position. In the embodiment shown, the three apertures 30, 32 and 34 are aligned one above the other. However, in alternate embodiments, the three apertures could be offset relative to each other.

The fuel delivery system 26 is very similar to the system described in U.S. patent application Ser. No. 09/518,578 which is hereby incorporated by reference in its entirety. The fuel delivery system generally comprises a carburetor unit 35. In this embodiment the carburetor unit 35 includes a carburetor adapter plate 36. A combined heat dam and wave guide conduit assembly 38 connects the carburetor unit 35 to the cylinder 22 and crankcase 23 of the engine. An air filter 44 is connected to an outward side of the carburetor unit 35. In an alternate embodiment, the check valve of the present invention could be used with any suitable type of carburetor. For example, the check valve of the present invention could be used with any suitably type of carburetor adapter plate, or carburetor unit, or heat dam and wave guide conduit assembly, or alternatives thereto.

Referring also to FIG. 3, the combined heat dam and wave guide conduit assembly 38 generally comprises a frame 46, a check valve 48, and a wave guide conduit tube 50. The frame 46 comprises a main air inlet channel 52, two conduit sections 54, 55 and an inlet 56 (see FIG. 2). The main air inlet channel 52 is connected to the inlet 32. The bottom conduit section 54 is connected to the port 30. The top conduit section 55 is connected to the inlet 56 which is connected to the port 34 into the combustion chamber of the cylinder 22. The tube 50 connects the two conduit sections 54, 55 to each other. The tube 50, in the embodiment shown, also functions as an accumulator. However, the tube 50 might be a wave guide conduit without being an accumulator.

The check valve 48 has an exit into the top conduit section 55. The check valve 48 allows fuel and air to be sucked into the conduit section 55 and tube 50 by suction from the crankcase applied at port 30, but substantially prevents hot combustion gases from the cylinder from passing through the check valve 48. The check valve 48 also substantially prevents the fuel/air charge in the tube 50 and conduit section 55 from re-entering back into the carburetor through the check valve 48. The frame 46 also includes three mounting holes for use with fasteners (not shown) to attach the assembly 38 to the cylinder 22. The channel 64 communicates with crankcase pressure through a hole 66.

The adapter 36 includes a pass-through flow hole 68, a pressure pass-through hole 70, and a channel 72 which extends into a post 74. The main flow channel 68 is aligned with the main channel 52 of the combined heat dam and wave guide conduit assembly 38. The pressure passthrough hole 70 is aligned with the top of the channel 64 on the outward side of the assembly 38. The channel 72 is connected to the check valve 48 at one end by the post 74 and a small piece of tube 76. The entrance into the channel 72 is aligned with a small air flow channel 73 from the carburetor unit 35. The main flow channel 68 is also aligned with the main air flow channel 78.

The inward facing side of the carburetor unit 35 is located against the outward facing side of the adapter 36. The outward facing side of the carburetor unit 35 has the air filter 44 located against it. The fuel pump 104 is located at the top of the frame 84. A fuel inlet connector connects a fuel line (not shown) from the gasoline tank (not shown) to the fuel pump 104. The fuel pump is preferably a diaphragm driven pump which is driven by crankcase pressures. However, any suitable fuel pump could be provided. An internal conduit (not shown) through the frame 84 supplies fuel from the pump 104 to the fuel meter 106. The fuel meter 106 is connected to the bottom of the frame 84.

The carburetor unit 35 preferably includes two fuel mixture needle screws connected to the frame 84 and intersecting fuel conduits (not shown). The fuel conduits extend past the needle screws to the air flow channels 73, 78. The frame 84 includes a channel 96 from the inward side of the frame 84 into the chamber 98 of the pump 104. Channels 96, 70, 64 and another (not shown) connect the chamber 98 to crankcase pressure in the crankcase 23 for driving the diaphragm 100 of the pump 104.

The frame 84 has a throttle shaft hole. The throttle shaft hole extends through the two air flow channels 78, 73, and also through a portion of an air bleed channel (not shown) and a portion of a channel that forms an accelerator pump (not shown). The throttle shaft assembly 58 generally comprises a shaft, a throttle plate, a spring and a control lever. The control lever is preferably connected by a control cable to the user actuated throttle trigger 20 (see FIG. 1). The spring biases the throttle shaft assembly at an idle position. The throttle plate is fixedly attached to the shaft and located in the main air channel 78. The throttle shaft includes two through-holes and a cut-out section. In a preferred embodiment the shaft also has an annular groove at the first through-hole. In a preferred embodiment O-ring seals are provided between the frame and the shaft on opposite sides of the groove.

In the idle position shown, the shaft blocks the accelerator pump channel and a portion of the air bleed channel and substantially blocks the small air flow channel (allowing a small amount of air and fuel to pass through a groove). The plate partially restricts air and fuel from passing through the channel 78. The throttle plate is moved to an open position to allow more air to pass through the channel 78 and allows less fuel to enter the channel 78 at wide open throttle than at idle. The fuel entering the channel 78 at wide open throttle is primarily used for lubrication of components in the crankcase and not for combustion. Thus, the channel 78 is not substantially used as a carburetor during wide open throttle, but primarily as an air inlet and lubricant supply conduit.

Throttle shaft assembly 58 can be used with the channel 78 at wide open throttle primarily as an air throttle; not a fuel/air throttle. This could also be true at idle if almost all the fuel is delivered by the tube 50 and other air channel 73 at idle. However, if the fuel for combustion at idle is delivered by the larger channel 78, it is preferred to allow at least some air and fuel to pass through the smaller channel 73 at idle in order to keep the smaller fuel supply system to the tube 50 in a wet condition or state.

The frame 84 includes a choke shaft hole. The hole passes through the two channels 73, 78, and a portion of the air bleed channel. The choke shaft assembly 60 generally comprises a shaft, a choke plate, and a user actuated control lever or handle. The choke plate is located in the main channel 78. The shaft assembly 60 is rotatable about 75° between the choke position and the non-choke position. The choke shaft has the choke plate fixedly attached to it and also comprises two through-holes. As the choke shaft is rotated between its choke and non-choke positions, the first hole is misaligned with and aligned with the smaller channel 73, respectively. Likewise, as the choke shaft is rotated between its choke and non-choke positions, the second hole is misaligned with and aligned with the portion of the air bleed channel (not shown). Thus, the choke shaft assembly 60 can open and block the air bleed channel as well as choke the two air channels 73, 78. The shaft preferably has an annular groove around the shaft at the hole such that a small amount of air can pass through the groove when the choke shaft assembly is in a choke position. In alternate embodiments, any suitable type of carburetor could be used.

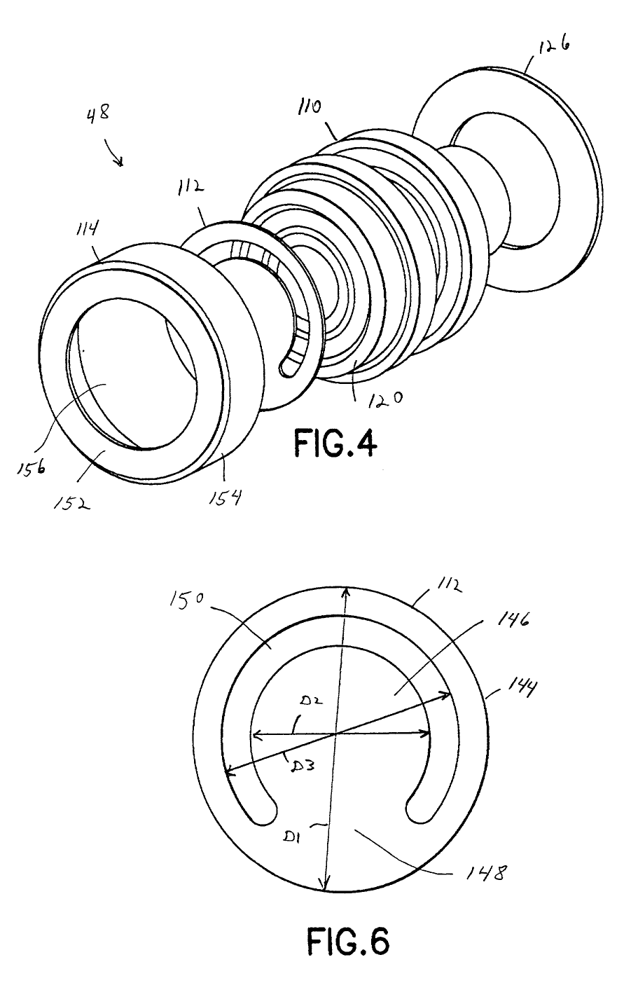

Referring now also to FIGS. 4-6, the check valve 48 generally comprises a valve body 110, a valve plate 112, a cap 114, and a seal 116. In alternate embodiments, the check valve could comprise additional or alternative components. The valve body 110 generally comprises a rear end 118, a front end 120 and a middle section having an annular groove 122. A channel 124 extends through the valve body from the rear end 118 to the front end 120. The rear end 118 is adapted to have the tube 76 mounted thereon.

A fastener 126 is provided to fixedly attach the check valve 48 inside a receiving area 128 of the frame 46 of the heat dam and wave guide conduit assembly 38 (see FIG. 2). As seen best in FIG. 4, the fastener 126 has a center aperture which is sized and shaped to pass over the rear end 118 of the valve body and press against the surface 130. The fastener 126 makes an interference fit with the receiving area 128. However, in alternate embodiments, any suitable means could be used to attach the check valve to the assembly frame 46.

The seal 116 comprises an O-ring. However, in alternate embodiments, any suitable type of seal could be provided. The seal 116 is located in the annular groove 122. The annular groove 122 is spaced from the front end 120 such that the seal 116 is also spaced from the front end 120.

The front end 120 of the valve body 110 comprises an exterior recess 132 which forms a stop surface 134. The front face of the front end 120 generally comprises an inner raised ring section 136, an outer raised seat section 138, and a recessed section 140 therebetween. The inner raised ring section 136 surrounds the outlet 142 of the channel 124. In the embodiment shown, the ring section 136 has a circular shape. However, in alternate embodiments, the ring section 136 could have other shapes, such as oval or square for example.

The outer raised seat section 138 is spaced from the inner raised ring section 136. In the embodiment shown, the outer raised seat section 138 as a general circular ring shape. However, in alternate embodiments, the outer raised seat section could have any suitable type of shape, such as spaced posts or a square or rectangular shape. The recessed section 140 is provided such that the inner and outer raised sections 136, 138 are the forward most sections of the front face of the valve body 110. In alternate embodiments, the front face of the valve body could have alternate shapes.

The valve plate 112 is preferably a one-piece member comprised of flat sheet metal. However, in alternate embodiments, the valve plate could be comprised of more than one member and could be comprised of any suitable type of material(s). The valve plate 112 generally comprises an outer section 144, an inner section 146 and a junction 148 between the inner and outer sections. A general C shaped aperture 150 is provided between the inner and outer sections except at the junction 148. In alternate embodiments the valve plate could have any suitable shape.

The outer section 144 has a general circular ring shape. However, in alternate embodiments, the outer section 144 could have any suitable type of shape. The inner section 146 extends from the outer section 144 in a general cantilever fashion. The inner section 146 has a general circular pedal shape with a base of the pedal being joined to the outer section 144 at the junction 148. The size of the inner section 146 is sufficiently large enough to cover the outlet 142 of the channel 124 with the rear surface of the inner section contacting the inner raised ring section 136. The size of the outer section 144 is sufficiently large enough to contact the outer raised seat section 138.

The cap 114 is preferably comprised of metal. The cap 114 generally comprises a front end 152, a side rim 154 and a center aperture 156 through the front end 152. A rear side of the front end 152 has a raised projection 158. The side rim 154 is sized and shaped to be press fit mounted on the front end 120 of the valve body 110. The rear end of the side rim 154 is adapted to stop against the stop surface 134.

The stop surface 134 positions the cap 114 at a predetermined position such that the rearward raised projection 158 stops at a location to form a gap G between the raised projection 158 and the outer raised seat section 138. The gap G is slightly larger than the thickness T of the valve plate 112. Thus, the whole valve plate 112 is adapted to move inside the gap G as indicated by arrow B. In the preferred embodiment shown, the valve plate 112 has a free boundary or movable boundary condition and is adapted to axially rotate. In an alternate embodiment the valve plate might have a free boundary condition, but not be adapted to axially rotate. In a preferred embodiment, the valve plate 112 has a thickness T of about 0.94-0.11 mm and the gap G is about 0.125-0.153 mm. However, any suitable dimensions could be provided. In a preferred embodiment, the valve plate 112 has an outer diameter D1 of about 7.88 mm and the pedal 146 has a diameter D2 of about 4.78 mm with the outer boundary of the slot 150 having an outer diameter D3 of about 6.35 mm. However, any suitable dimensions could be provided.

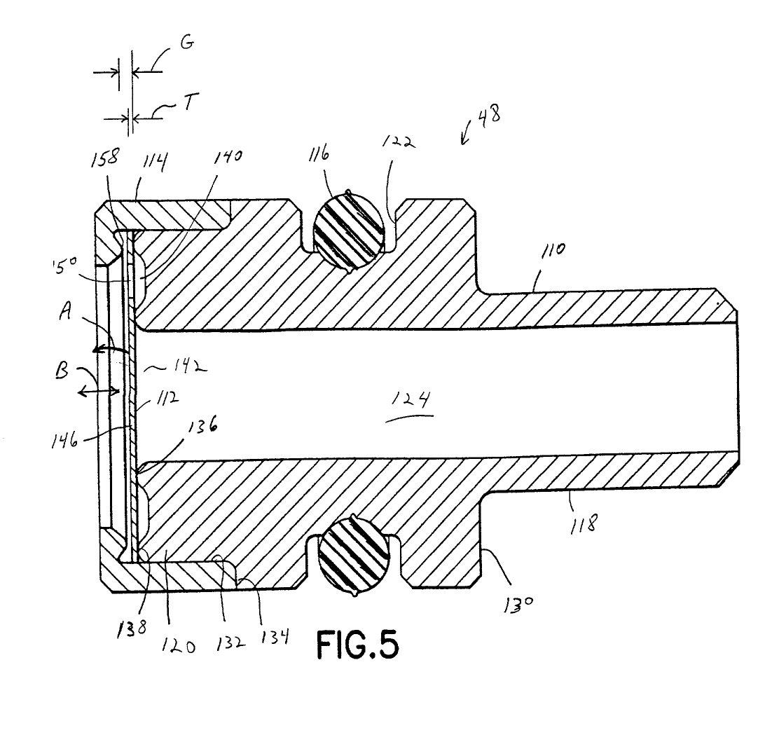

FIG. 5 shows the valve plate 112 at a closed position with its inner section 146 against the inner raised ring section 136; closing the outlet 142 of the channel 124. This closed position is normally maintained by surface tension of fuel located between the rear surface of the inner section 146 and the front face of the inner raised ring section 136. The pressure of gases inside the tube 50 and channel 55 pushing against the front face of the plate 112 can also help keep the valve plate in its closed position; such as combustion gases entering through the aperture 34 or compressed air entering through the aperture 30.

The valve plate 112 can move from its closed position to an open position based upon a reduction in gas pressure or vacuum force inside the conduit 55 and tube 50. The movement of the plate 112 can comprise a unique type of two step movement. The first step can comprise the inner section 146 moving away from the raised section 136; breaking the retainment by surface tension. The second step can comprise the rest of the valve plate 112 moving forward away from the front end of the valve body including the outer section 144 moving away from the outer raised seat section 138.

When the piston is moving up in the cylinder (towards its top dead center position) and the injection port 34 is covered by the piston, vacuum pressure is transmitted from the area behind the bottom of the piston head through the aperture 30 and conduit section 54 into the tube 50 and conduit 55. The inner section 146 of the valve plate 112 is pulled by the vacuum force in an outward or forward direction. The surface tension retainment of the inner section 146 to the front end of the valve body at inner raised ring section 136 can be broken by this vacuum force and, the inner section 146 can resiliency deflect outward as indicated by arrow A in a general cantilever fashion. This can open the outlet 142, at least partially, such that fuel and air in the channel 124 can be drawn or sucked into the conduit section 55 and tube 50. The aperture 156 in the cap 114 provides a space for the inner section 146 to deflect outward.

In addition to the flap 146 deflecting away from the front end 120 of the valve body in a general cantilever fashion, the rest of the valve plate 112 can now also move away from the front end 120. In other words, the whole valve plate 112 can fly off of contact with the front end of the valve body 110. The cap 114 keeps the valve plate 112 with the assembly and keeps the valve plate 112 at a suitable location relative to the front face of the valve body's front end for re-positioning on the front end at a later time when flow direction changes with pressure.

When the vacuum pressure ceases, such as when the aperture 32 becomes open as the bottom of the piston head uncovers the bottom of the aperture 32, the flap 146 resiliently deflects back to its normal undeflected position relative to the outer section 144. However, the valve plate 112 still does not close the outlet 142 because the plate 112 is spaced from the front end of the valve body 110. After combustion, the injection port 34 is exposed to an inflow of gases and a pressure pulse from combustion. The inflow of combustion gases and pressure pulse in the conduit section 55 results in the valve plate 112 being pushed back against the front end of the valve body 110. The inner section 146 once again comes to rest against the inner raised seat section 136 and is retained therewith by surface tension and the force against its front face. The outer section 144 once again comes to rest against the outer raised seat section 138. The flap 146 prevents combustion gases and the pressure pulse from entering into the channel 124. Because the valve plate 112 is comprised of metal, the valve plate can withstand the heat and pressure generated from combustion gases entering into the inlet 56 and conduit section 55.

The valve of the present invention does not function merely as a reed valve. Instead, the whole valve plate can move and its position can be controlled by gas dynamics. The first step movement of the inner section 146 acts as a mechanical switch to allow the whole plate to move away from the valve body. The supports between the valve plate and the front end of the valve body and the ability of the entire valve plate to fly off of the front face of the valve body prevent permanent deformation or cupping of the valve plate by the forces against it. This can be particularly important for such a small thickness, lightweight valve plate which otherwise could be permanently deformed by excessive strain by over bending of the junction 148 or cupping at the inner section 146.

The limited area of contact between the flap 146 and the front face of the valve body 110 limits significant variation of opening pressures of the flap 146 in the presence of liquid films or wetting, such as fuel or oil. The present invention can allow use of very low differences in pressure as control pressures which open and close the check valve in response to a gas flow direction in the conduit section 55. The valve flap 146 and inner raised ring section 136 provide a seal and the outer section 144 and outer section 138 provided a boundary seat which provide positive seal behavior against backflow. The present invention provides minimal backflow dynamic pressures which is ideal for isolation of carburetor metering. The valve plate 112 has a light weight design which can provide high frequency check response, such as 250 CPS (cycles per second) or 15,000 CPM (cycles per minute). The check valve 48 can control back flow of gas/liquid flow in a mixed state. The check valve 48 can act as a check disc/reed pedal combination with an initial small throw of the flap, but a reed designed to increase flow area. The present invention can provide an unconstrained boundary condition in the flow direction.

The valve plate 112 can be comprised of material, such as metal, which is capable of withstanding elevated temperatures without signs of distortion; preventing checked/sealed flow and providing means to increase fuel preparation and vaporization prior to injection in a direct fuel injection engine application. Free boundary conditions of the valve plate edge provides no preload or initial deflections associated with biased base plates or fasteners. The present invention can provide for an easy assembly and more consistent performance because the valve plate is not preloaded to a predetermined control specification. The disk clearance (G-T) is controlled by the valve cap stop surface pressing on the valve body to act as a positive stop.

The valve plate 112 can have a radial float and a float in direction B. The valve plate 112 can have smooth, continuous bur-free edges which avoid stress concentration which typically leads to premature failure. Stress concentration is normally associated with reed fasteners, holes and plates. Metal to metal sealing of the valve plate 112 with the valve body 110 avoids the need to use high-temperature rubber or plastic. The check valve 48 can provide a complete and uniform support of the outer section 144 and edges of the inner pedal 146 by the use of the concentric seat surfaces (annular bosses) which minimizes cupping. A prior art fixed boundary type of reed has a natural tendency to close based on this stiffness. However, the valve plate 112 has no inherent stiffness limiting initial opening motion due to the free boundary conditions. Surface tension located between the inner section 146 and the inner raised ring section 136 can act as a load or preload to retain the inner section 146 over the outlet 146. The present invention can use a free (i.e., non-fixed or movable) boundary type of valve. The check valve 48 of the present invention has no need for a seat plate or backing plate.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. In an internal combustion engine including a cylinder and a fuel delivery system for delivering a fuel and air mixture into the cylinder, the improvement comprising:
the fuel delivery system comprising a rapid action check valve located between a fuel source and a conduit to a combustion chamber of the cylinder, the check valve being exposed to pressure pulses in the conduit from combustion in the combustion chamber and vacuum pulses in the conduit, the rapid action check valve comprising a valve body having a channel therethrough and a valve plate connected to a front end of the valve body, wherein the valve plate comprises an outer section and a center cantilevered flap, wherein the outer section has a general ring shape, and wherein the cantilevered flap extends inward from the outer section in a generally cantilevered fashion, the cantilevered flap being located at a front end of the valve body at the channel and being deflectably moveable in a forward direction away from the channel.

2. An internal combustion engine as in claim 1 wherein the outer section of the valve plate as a general continuous closed loop shape.

3. An internal combustion engine as in claim 2 wherein the cantilevered flap has a general pedal shape with a base of the general pedal shape being located at a junction of the flap to the outer section.

4. An internal combustion engine as in claim 1 wherein the valve plate is comprised of a flat sheet metal member.

5. An internal combustion engine as in claim 4 wherein the valve plate comprises a general C shaped aperture between the outer section and the cantilevered flap.

6. An internal combustion engine as in claim 5 wherein the valve plate has a general circular profile.

7. An internal combustion engine as in claim 1 wherein the front end of the valve body comprises an inner raised ring section surrounding an outlet of the channel and an outer raised seat section spaced from the inner raised ring section.

8. An internal combustion engine as in claim 7 wherein the outer raised seat section comprises a general ring shape.

9. An internal combustion engine as in claim 7 further comprising a cap connected to the front end of the valve body.

10. An internal combustion engine as in claim 9 wherein the cap comprises an aperture, and wherein the cantilevered flap is adapted to move into the aperture when the flap moves away from the outlet of the channel.

11. An internal combustion engine as in claim 10 wherein the outer section of the valve plate is located between the outer raised seat section and the cap.

12. An internal combustion engine as in claim 1 wherein the outer section is movably mounted between the front end of the valve body and a cap mounted to the front end.

13. An internal combustion engine as in claim 12 wherein the outer section is adapted to axially rotate in an area between the cap and the valve body.

14. An internal combustion engine as in claim 1 wherein the valve plate is movably mounted to the valve body with a free boundary movement ability.

15. An internal combustion engine as in claim 1 wherein the valve plate is movably connected to the valve body to movably float in a gas flow direction.

16. A valve comprising:
a valve body having a channel therethrough;
a valve disc having an outer section and a flap extending in a cantilever fashion inward from the outer section;
a cap connected to the valve body, the outer section of the valve disk being movably located between the valve body and the cap, and the cap having a hole for the flap of the valve disk to move in.

17. A valve as in claim 16 wherein the outer section is adapted to axially rotate in an area between the cap and the valve body.

18. A valve as in claim 16 wherein the valve plate is comprised of a flat sheet metal member.

19. A valve as in claim 18 wherein the valve plate comprises a general C shaped aperture between the outer section and the cantilevered flap.

20. A valve as in claim 19 wherein the valve plate has a general circular profile.

21. A valve as in claim 16 wherein a front end of the valve body comprises an inner raised ring section surrounding an outlet of the channel and an outer raised seat section spaced from the inner raised ring section.

22. A valve as in claim 21 wherein the outer raised seat section comprises a general ring shape.

23. An internal combustion engine fuel check valve comprising:
a valve body having a channel therethrough;
an annular seal connected around an outside of the valve body;
a valve plate comprised of a sheet metal member, the valve plate having an outer section and a cantilevered flap extending from the outer section, the flap being resiliently movable relative to the outer section at a junction between the flap and the outer section;
a valve cap connected to the valve body and capturing at least a portion of the outer section between the valve cap and the valve body, the valve cap having an aperture therethrough, the flap being flexibly movable at a front end of the channel at the aperture,
wherein the valve body is sized and shaped to be inserted into a conduiting member having a fuel inlet channel connectable to a combustion chamber of an internal combustion engine with the seal being located between the valve body and the conduiting member spaced from the fuel inlet channel.

24. An internal combustion engine fuel check valve as in claim 23 wherein the valve plate is mounted to movably float relative to the valve body and the valve cap.
